(19) United States
(12) Patent Application Publication
(10) Pub. No.: US 2004/0109074 A1
(43) Pub. Date: Jun. 10, 2004

(54) Image sensor and optical pointing system using the same

(76) Inventor: Duck Young Jung, Yongin-city (KR)

Correspondence Address: CANTOR COLBURN LLP, 55 Griffin Road South, Bloomfield, CT, 06002, US

(21) Appl. No.: 10/728,243

(22) Filed: Dec. 4, 2003

(30) Foreign Application Priority Data
Dec. 5, 2002 (KR) 2002-77099

(51) Int. Cl. H04N 5/335

(52) U.S. Cl. 348/308; 348/222.1

(57) ABSTRACT

Disclosed is an image sensor and optical pointing system using the same. The image sensor is constituted of a plurality of pixels, each of which comprises a photocell for receiving light and generating an analog signal corresponding to a quantity of the received light, a comparator for comparing the analog signal of the photocell and a reference signal and generating a digital signal having a value of the compared result, and a switch for outputting the digital signal of the comparator. The image sensor performs digital conversion and pre-filtering through the comparator, thus allowing 1-bit digital signals to be outputted. Further, the optical pointing system can provide a minimized layout area because an A/D converter and a pre-filter having high resolution are not separately required, and can provide a minimized chip size when implemented as a semiconductor integrated circuit.

### CROSS-REFERENCE TO RELATED APPLICATION

This application claims the benefit of Korean Patent Application No. 2002-77099, filed Dec. 5, 2002, the disclosure of which is hereby incorporated herein by reference in its entirety.

### BACKGROUND OF THE INVENTION

1. Field of the Invention

The present invention relates to an image sensor and, more particularly, to an image sensor for detecting light and an optical pointing system using the same.

2. Description of the Related Art

A conventional image sensor is configured of an N×N pixel array and obtains a two-dimensional image of a subject. Each pixel of the pixel array generates an analog signal having a voltage value corresponding to the brightness of a corresponding image area, and the image sensor outputs N² number of analog signals generated from each pixel.

FIG. 1 shows an internal block diagram of a conventional optical pointing system with an image sensor, in which the optical pointing system includes an image sensor 1, an A/D converter 2, a pre-filter 3, an image processor 4 and a shutter control circuit 5.

The image sensor 1 obtains a two-dimensional image of a subject and generates and outputs N² number of output signals having analog voltage values corresponding to the brightness of each area of the obtained image.

The A/D converter 2 converts each of the output signals outputted from the image sensor 1 into digital signals having an n-bit structure (hereinafter, called an “n-bit digital signal”), and the pre-filter 3 converts each of the converted n-bit digital signals outputted from the A/D converter 2 into digital signals having a 1-bit structure (hereinafter, called a “1-bit digital signal”).

The image processor 4 detects an image of the subject using the 1-bit digital signals converted through the pre-filter 3, compares the detected current image of the subject and the detected previous image of the subject, calculates a movement value V(K), and outputs the calculated movement value V(K).

Here, the shutter control circuit 5 responds to the n-bit digital signals outputted from the A/D converter 2 to generate a shutter control signal CSH, and provides the generated shutter control signal CSH to the image sensor 1.

The shutter control signal CSH controls an exposure time of the image sensor 1 to cause a quantity of light incident onto the image sensor 1 to maintain a given average value at any time, thus allowing the image sensor 1 to obtain an exact image of the subject.

In this manner, the conventional optical pointing system minimizes the number of bits of data needed to calculate the movement value and provides the result to the image processor, so that it may have a fast response characteristic.

However, in the case of the conventional optical pointing system, there is a problem in that it must include the A/D converter and the pre-filter in order to provide the minimized 1-bit digital signal to the image processor, so that its layout is increased in proportion to the areas the AND converter and the pre-filter. In other words, when it is implemented as a semiconductor integrated circuit, there is a problem in that the AND converter and the pre-filter cause chip size to be increased.

### SUMMARY OF THE INVENTION

It is, therefore, an object of the present invention to provide an image sensor capable of performing a signal processing function and outputting digital signals.

It is another object of the present invention to provide an optical pointing system capable of decreasing a layout area using the image sensor.

In order to accomplish the former object, according to a first aspect of the present invention, there is provided an image sensor having a plurality of pixels, each pixel comprising a photocell for receiving light and generating an analog signal corresponding to a quantity of the received light, a comparator for comparing the analog signal of the photocell with a reference signal and generating a digital signal having a value of the compared result, and a switch for outputting the digital signal of the comparator.

In order to accomplish the former object, according to a second aspect of the present invention, there is provided an image sensor comprising: a) a plurality of pixels, each having a first photocell for receiving light and generating a first analog signal corresponding to a quantity of the received light, a comparator for comparing the analog signal of the first photocell with a reference signal and generating a digital signal having a value of the compared result, and a switch for outputting the digital signal of the comparator; and b) at least one second photocell for generating a second analog signal corresponding the received quantity of light. Here, the digital signal is a digital signal having a 1-bit structure.

Further, the reference signal of the image sensor is an analog signal of a photocell of an adjacent pixel.

Preferably, the reference signal of the image sensor is a reference voltage.

Here, at least one of the first and the second photocells comprises a photo diode and a transistor, the photodiode generating a photocurrent corresponding to the received quantity of light.

Further, the comparator of the image sensor is a latch type comparator which outputs a first signal when the analog signal of any one of the first and second photocells is greater than the reference signal and outputs a second signal when the analog signal of any one of the first and second photocells is less than the reference signal.

In order to accomplish the latter object, according to a first aspect of the present invention, there is provided an optical pointing system comprising: a) a plurality of pixels, each having a photocell for receiving light and generating an analog signal corresponding to a quantity of the received light, and a comparator for comparing the analog signal of the photocell with a reference signal and generating a digital signal having a value of the compared result; b) an image processor for calculating a movement value using the digital signals outputted from the plurality of pixels and generating a pixel select signal and a shutter control information signal; and c) a shutter control circuit for generating a shutter control signal corresponding to the shutter control information signal of the image processor. According to a second aspect of the present invention, there is provided an optical pointing system comprising: a) a plurality of pixels, each having a first photocell for generating a first analog signal corresponding to a received quantity of light, and a comparator for comparing the first analog signal of the first photocell and a reference signal and generating a digital signal having a value of the compared result; b) at least one second photocell for generating a second analog signal corresponding the received quantity of light; c) an image processor for calculating a movement value using the digital signals outputted from the comparators and generating a pixel select signal; and d) a shutter control circuit for generating a shutter control signal using the second analog signal outputted from the second photocell.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates an internal block diagram of a conventional optical pointing system with an image sensor;

FIG. 2 illustrates a configuration of an image sensor according to a first embodiment of the present invention;

FIG. 3 is a detailed circuit diagram of the unit pixel of FIG. 2;

FIG. 4 is an internal block diagram illustrating the optical pointing system with the image sensor of FIG. 2;

FIG. 5 illustrates a configuration of an image sensor according to a second embodiment of the present invention; and

FIG. 6 is an internal block diagram illustrating the optical pointing system with the image sensor of FIG. 5.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

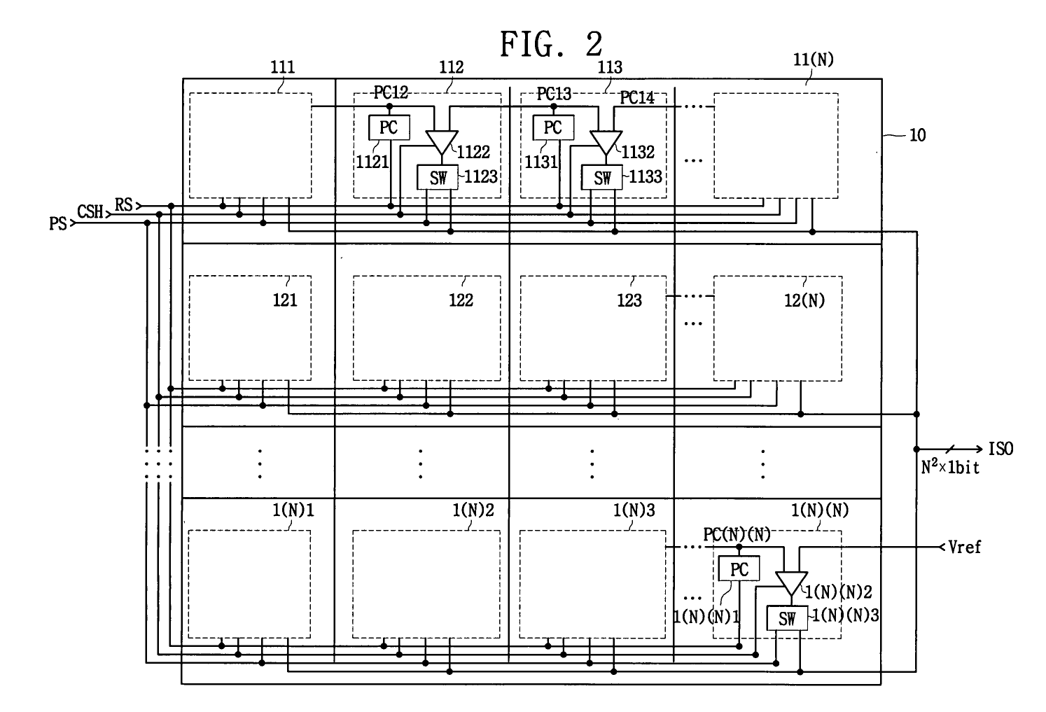

FIG. 2 illustrates a configuration of an image sensor according to a first embodiment of the present invention.

Referring to FIG. 2, the image sensor 10 of the present invention includes a plurality of pixels 111 to 1NN composed of an N×N pixel array (where, N is the positive integer). Each pixel, for example, a pixel 112 has a photocell 1121, a comparator 1122 and a switch 1123.

The plurality of pixels 111 to 1NN obtain a two-dimensional image of a subject under the control of a reset signal RS and a shutter control signal CSH, and each pixel generates a 1-bit digital signal ISO having a value corresponding to the brightness of an image area thereof.

The image sensor 10 outputs N² number of 1-bit digital signals ISO, which are generated through the plurality of pixels 111 to 1NN, to the outside under the control of a pixel select signal PS.

Description of each pixel of the image sensor 10, for example the pixel 112, will be made in more detail below.

The photocell 1121 of the pixel 113 performs initialization operation in response to the reset signal RS. When completing the initialization operation, the photocell 1121 generates an analog signal PC12 having a voltage value proportional to a quantity of incident light.

The generated analog signal PC12 is provided to the comparator 1122 of the corresponding pixel 112 and a comparator 1132 of an adjacent pixel 113.

The comparator 1122 compares an output signal PC12 of the photocell 1121 located within the corresponding pixel 112 with an output signal PC13 of the photocell 1131 located within the adjacent pixel 113 under the control of the shutter control signal CSH.

As a result of being compared by the comparator 1122, when a voltage value of the output signal PC12 of the photocell 1121 located. within the corresponding pixel 112 is greater than that of the output signal PC13 of the photocell 1131 located within the adjacent pixel 113, a high level of 1-bit digital signal is generated. However, when the voltage value of the output signal PC12 of the photocell 1121 is less than that of the output signal PC13 of the photocell 1131, a low level of 1-bit digital signal COMO12 is generated.

At this time, in the case of a comparator 1NN2 contained in a pixel 1NN without the adjacent pixel, either a reference voltage Vref generated by a reference voltage generation circuit (not shown) or an output signal of another adjacent pixel may be used.

Here, the comparator 1122 is a latch type comparator, which operates like a memory under the control the shutter control signal CSH and maintains the 1-bit digital signal generated by the comparison.

In this respect, the comparator 1122 performs a shutter function, so that the image sensor of the present invention does not require a separate shutter structure.

The switch 1123 receives the output signal COMO12 of the comparator 1122 and outputs the received output signal COMO12 to the outside under the control of the pixel select signal PS.

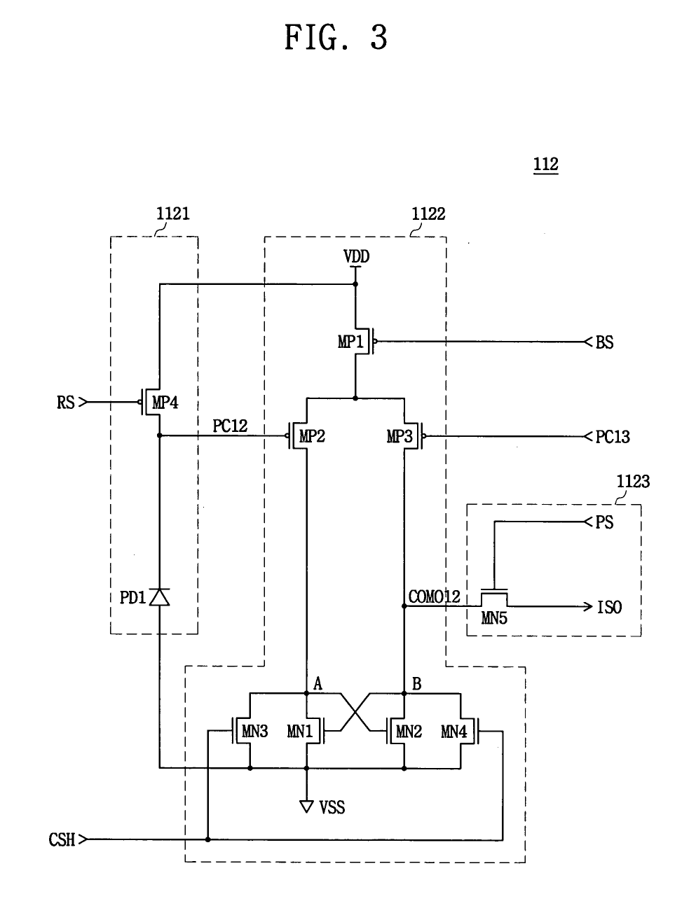

FIG. 3 is a detailed circuit diagram of the unit pixel 112 of FIG. 2.

Referring to FIG. 3, the unit pixel 112 of the present invention includes the photocell 1121, the comparator 1122 and the switch 1123. The photocell 1121 includes a first photo diode PD1 and a fourth PMOS (P-channel Metal Oxide Semiconductor) transistor MP4, wherein the first photo diode PD1 receives light with an anode connected to a ground VSS and generates a photocurrent I_{PH} proportional to a quantity of the received light, and the fourth PMOS transistor MP4 has a source terminal connected to a power supply voltage VDD, a gate terminal to which a reset signal RS is applied, and a drain terminal connected to a cathode of the first photo diode PD1. Here, the first photo diode PD1 of the photocell 1121 has a parasitic capacitor (not shown) in itself according to characteristics of a general photo diode circuit.

The comparator 1122 includes a first PMOS transistor MP1 having a source terminal connected to the power supply voltage VDD and a gate terminal to which a bias control signal BS is applied, a second PMOS transistor MP2 having a source terminal connected to the first PMOS transistor MP1 and a gate terminal to which an analog signal PC10 of the photocell 1121 is applied, a third PMOS transistor MP3 having a source terminal connected to the first PMOS transistor MP1 and a gate terminal to which an analog signal PC13 of the adjacent photocell 1131 (not shown) is applied, a first NMOS (N-channel metal oxide semiconductor) transistor MN1 having a drain terminal connected to a drain terminal of the second PMOS transistor MP2 and a source terminal connected to the ground VSS, a second NMOS transistor MN2 having a drain terminal connected to a drain terminal of the third PMOS transistor MP3 and a source terminal connected to the ground VSS, a third NMOS transistor MN3 having a drain terminal connected to a drain terminal of the second PMOS transistor MP2, a gate terminal to which the shutter control signal CSH is applied and a source terminal connected to the ground VSS, and a fourth NMOS transistor MN4 having a drain terminal connected to a drain terminal of the third PMOS transistor MP3, a gate terminal to which the shutter control signal CSH is applied and a source terminal connected to the ground VSS.

The switch 1123 includes a fifth NMOS transistor MN5 having a gate terminal receiving the pixel select signal PS, a drain terminal to which the digital signal COMO12 of the comparator 1122 is applied and a source terminal to which a digital signal ISO of the image sensor is outputted.

An operation of the unit pixel 112 configured as above will be described as follows.

An initial voltage of the first photo diode PD1 initialized by the low level of reset signal RS is set up only in case of need either at initialization time immediately after application of power or during an operation. And, at initialization time during the operation, the high level of shutter control signal CSH and a proper level of bias signal BS are applied. The bias signal BS stably operates in the circuit when it does not perform an on/off operation, but it may perform the on/off operation at initialization time in order to reduce the current consumption. At initialization time during the operation, the first PMOS transistor MP1 turns off in response to the high level of bias signal BS, and the third and fourth NMOS transistors MN3 and MN4 turn on in response to the high level of shutter control signal CSH. Thereby, nodes A and B become a level of ground voltage. Therefore, at initialization time during the operation, the operation of the comparator 1122 is disabled, and the output signal COMO12 of the ground voltage level is generated.

In this state, when the proper level of bias voltage BS is applied and the shutter control signal CSH is transferred to a low level, the fourth PMOS transistor MP4 and the third and fourth NMOS transistors MN3 and MN4 turn off and the first PMOS transistor MP1 turns on, and thus the operation of the comparator 1122 is enabled. As a result, the unit pixel 112 can detect a quantity of light.

If the first photodiode PD1 of the unit pixel 112 receives more quantity of light than that of an adjacent photodiode (not shown) of the adjacent unit pixel 113, a current flowing through the first photodiode PD1 is more than that flowing through the adjacent photodiode (not shown).

Thereby, the output signal PC12 has a lower voltage than the output signal PC13.

In that case, the current flowing through the second PMOS transistor MP2 becomes more than that flowing through the third PMOS transistor MP3, and thus the voltage of the node A becomes higher than that of the node B.

Further, when the voltage of the node A becomes high enough to turn on the second NMOS transistor MN2, the voltage of the node B becomes the ground voltage level. In other words, the output signal COMO12 becomes the low level.

Then, when the high level of pixel select signal PS is applied to the switch 1123, the fifth NMOS transistor MN5 turns on, and the low level of output signal COMO12 is transmitted as the signal ISO.

By contrast, if the first photodiode PD1 of the unit pixel 112 receives less quantity of light than that of the adjacent photodiode (not shown) of the adjacent unit pixel 113, the current flowing through the first photodiode PD1 is less than that flowing through the adjacent photodiode (not shown).

Thereby, the output signal PC12 has a higher voltage than the output signal PC13. Then, the current flowing through the third PMOS transistor MP3 becomes more than that flowing through the second PMOS transistor MP2, and thus the voltage of the node B becomes higher than that of the node A.

Further, when the voltage of the node B becomes high enough to turn on the first NMOS transistor MN1, the voltage of the node A becomes the ground voltage level and the voltage of the node B becomes higher. In other words, the output signal COMO12 becomes the high level.

Then, when the high level of pixel select signal PS is applied to the switch 1123, the fifth NMOS transistor MN5 turns on, and the high level of output signal COMO12 is transmitted as the signal ISO.

As such, the unit pixel of the present invention includes the comparator 1122 operating in a latch type, thereby providing the same effects as the case of employing an A/D converter having a considerable level of resolution.

Further, since the comparator 1122 maintains the 1-bit digital signal COMO12 generated by a comparison operation until the next shutter control signal CSH is applied, the comparator 1122 does not require a separate shutter structure.

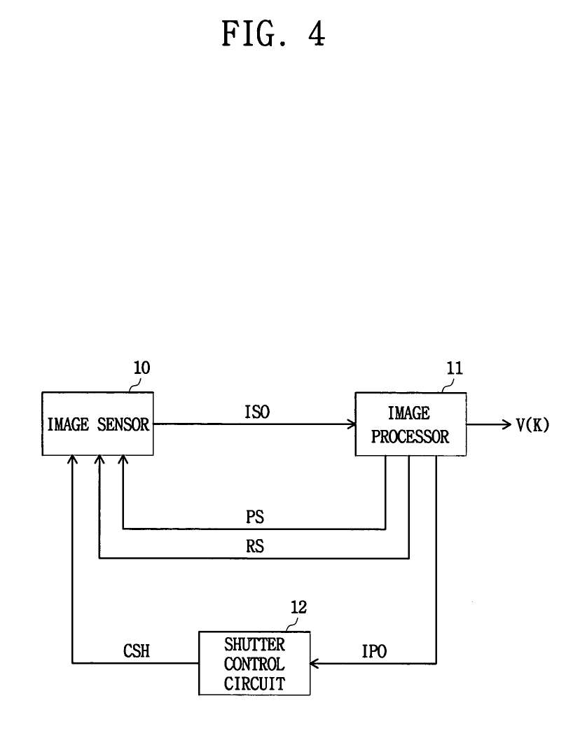

FIG. 4 is an internal block diagram illustrating the optical pointing system with the image sensor of FIG. 2.

Referring to FIG. 4, the optical pointing system of the present invention further comprises an image processor 11 and a shutter control circuit 12, in addition to the image sensor 10 of FIG. 2.

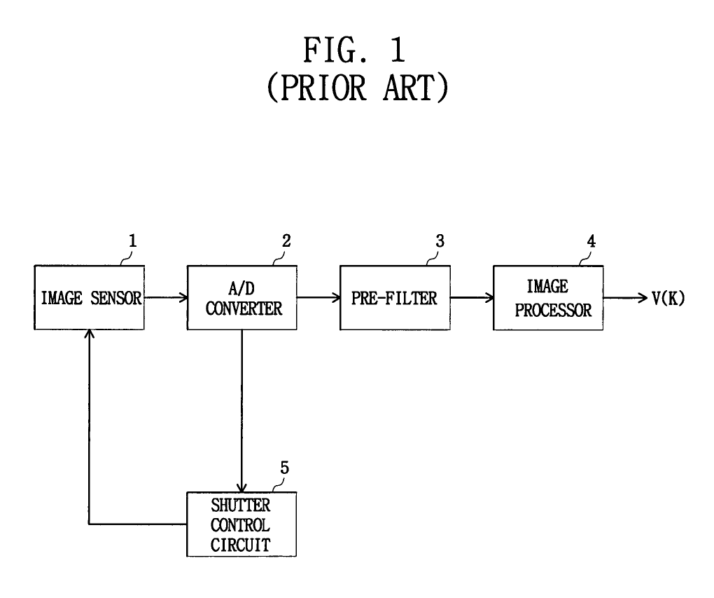

The image sensor 10 of FIG. 4 has the same structure and operation as that of FIG. 1. Hence, its detailed description will be omitted.

The image sensor 10 generates N² number of 1-bit digital signals ISO having values corresponding to the brightness of each image area and outputs the generated 1-bit digital signals to the outside.

The image processor 11 obtains an image of a subject using the N² number of 1-bit digital signals ISO received from the image sensor 10, compares the obtained present image of the subject with the previous image of the subject to calculate a movement value V(K), and then outputs the calculated movement value V(K).

Further, the image processor 11 generates the reset signal RS for initializing each pixel of the image sensor 10 and the pixel select signal PS for receiving the N² number of 1-bit digital signals ISO from the image sensor 10 and then provides the generated results to the image sensor 10. In addition, the image processor 11 generates a shutter information provision signal IPO (a signal for providing shutter information) for controlling an exposure time of a shutter of the image sensor 10 and then provides the generated result to the shutter control circuit 12. In the case that the shutter control circuit 12 performs an active function for calculating a complicated shutter on period, the shutter information provision signal IPO may be a simple start signal of indicating a time to be operated. However, in the case that the shutter control circuit 12 performs a simple passive function, the shutter information provision signal IPO must be a signal including information on a period in which the shutter must be turned on.

The shutter control circuit 12 generates the shutter control signal CSH in response to the shutter information provision signal IPO given from the image processor 11, and then provides the generated result to the image sensor 10.

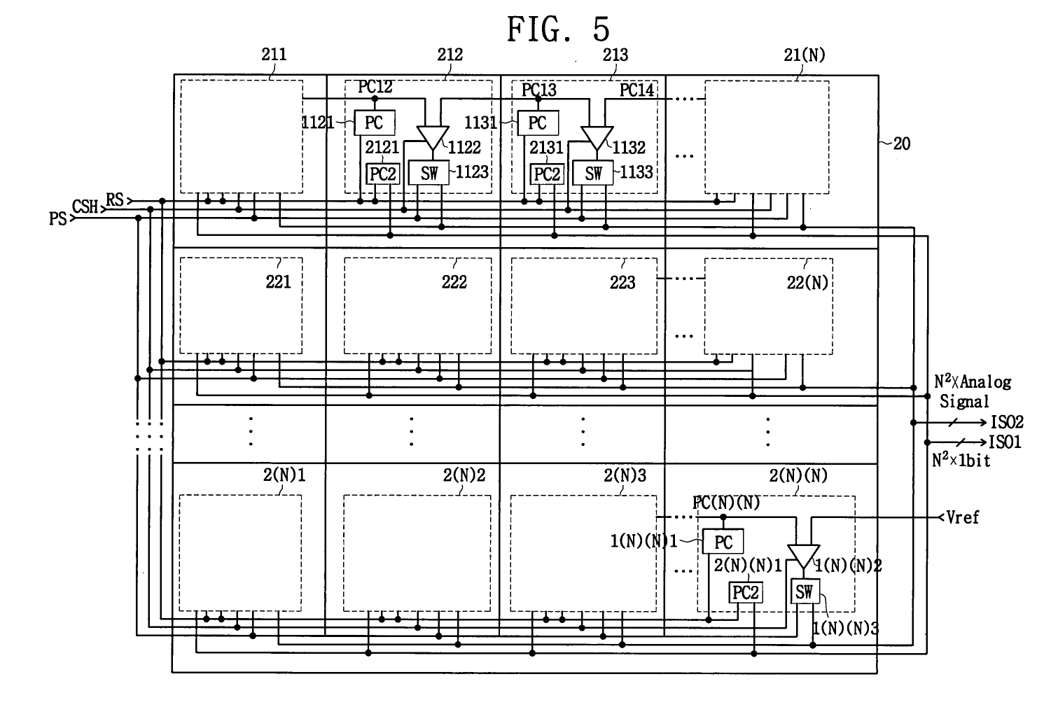

FIG. 5 illustrates a configuration of an image sensor according to a second embodiment of the present invention.

Referring to FIG. 5, an image sensor 20 of the present invention includes a plurality of pixels 211 to 2NN composed of an N×N pixel array (where, N=positive integer). Each pixel, for example, a pixel 212 has the first photocell 1121, the comparator 1122 and the switch 1123 like that of FIG. 2, but it further comprises a second photocell 2121Circuits having the same structure and operation as those of FIG. 2 will be given the same reference numerals as those of FIG. 2, so their detailed descriptions will be omitted.

Now, referring to FIG. 5, each pixel 212 of the image sensor 20 generates a 1-bit digital signal ISO1 having a value corresponding to the brightness of an image area of each pixel through the first photocell 1121, the comparator 1122 and the switch 1123, and generates a shutter information provision signal ISO2 having a value corresponding to the brightness of the image area of each pixel through the second photocell 2121.

The image sensor 20 outputs both the N² number of 1-bit digital signals ISO1 generated through the plurality of pixels 211 to 2NN and the N² number of shutter information provision signals ISO2 to the outside, where N is the positive integer number.

Here, the second photocell 2121 may be arranged either on a region where the first photocell 1121 of the corresponding pixel 212 is located or in a place where the comparator 1122 is located.

Further, if some error is taken into consideration, the image sensor 20 may be configured to one or more second photocells that are not located at each pixel in common instead of the second photocells that are located at each pixel. In this case, the one or more second photocells may be arranged either on an edge of the pixel array of the image sensor 20 or a free space of each pixel within the pixel array.

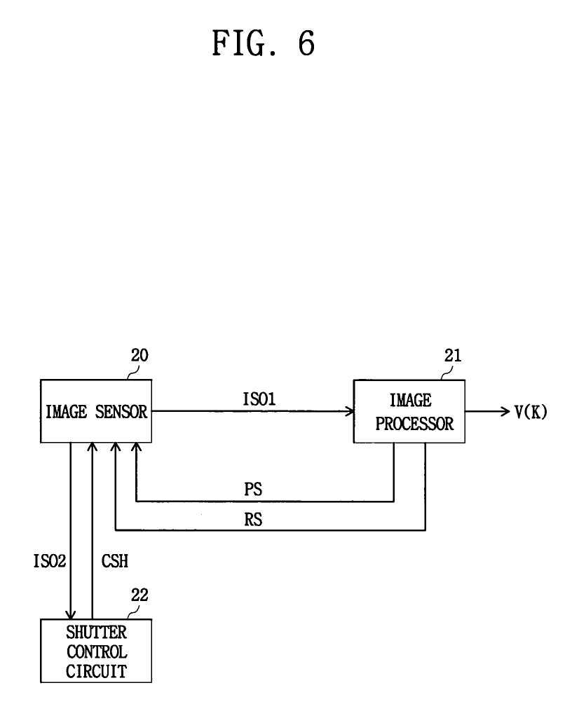

FIG. 6 is an internal block diagram illustrating the optical pointing system with the image sensor of FIG. 5.

As shown, the optical pointing system according to FIG. 6 provides a shutter control circuit 22 with shutter information provision signals ISO2 of the image sensor 20 unlike the optical pointing system of FIG. 4.

Subsequently, referring to FIG. 6, the optical pointing system of the present invention includes the image sensor 20, an image processor 21 and the shutter control circuit 22. The image sensor 20 generates N² number of 1-bit digital signals ISO1 having a value corresponding to the brightness of each image area and N² number of shutter information provision signals ISO2 having a voltage value corresponding to the brightness of each image area and outputs to the outside.

The image processor 21 obtains an image signal of a subject using the N² number of 1-bit digital signals ISO1 received from the image sensor 20, compares the obtained current image of the subject with the previous image of the subject to calculate a movement value V(K), and then outputs the calculated movement value V(K).

Further, the image processor 21 generates the reset signal RS for initializing each pixel of the image sensor 20 and the pixel select signal PS for receiving the N² number of 1-bit digital signals ISO1 from the image sensor 20 and then provides the generated results to the image sensor 20.

The shutter control circuit 22 receives the N² number of shutter information provision signals ISO2 given from the image sensor 20, responds to the received N² number of shutter information provision signals ISO2 to generate the shutter control signal CSH, and provides the generated shutter control signal CSH to the image sensor 20.

While preferred embodiments of the present invention have been specifically described, but those skilled in the art will understand that various modifications, additions and substitutions are possible without departing from the scope and the spirit of the invention as defined in the appended claims.

As set forth above, in the case of the image sensor and the optical pointing system using the same according to the present invention, the image sensor performs functions of digital conversion and pre-filtering through the comparator of each pixel, and thus it is possible to output 1-bit digital signals. Further, the A/D converter and the pre-filter having high resolution are not separately required, so that it is possible to decrease a layout area.

What is claimed is:

1. An image sensor having a plurality of pixels, each pixel comprising:
a photocell for receiving light and generating an analog signal corresponding to a quantity of the received light;
a comparator for comparing the analog signal of the photocell and a reference signal and generating a digital signal having a value of the compared result; and
a switch for outputting the digital signal of the comparator.

2. The image sensor as claimed in claim 1, wherein the digital signal is a digital signal having a 1-bit structure.

3. The image sensor as claimed in claim 1, wherein the reference signal is an analog signal of a photocell of an adjacent pixel.

4. The image sensor as claimed in claim 1, wherein the reference signal is a reference voltage.

5. The image sensor as claimed in claim 1, wherein the photocell is a photo diode that generates a photocurrent corresponding to the received quantity of light.

6. The image sensor as claimed in claim 1, wherein the comparator is a latch type comparator which outputs a first signal when the analog signal of the photocell is greater than the reference signal and outputs a second signal when the analog signal of the photocell is less than the reference signal.

7. An image sensor comprising:
a) a plurality of pixels, each having
a first photocell for receiving light and generating a first analog signal corresponding to a quantity of the received light,
a comparator for comparing the analog signal of the first photocell and a reference signal and generating a digital signal having a value of the compared result, and
a switch for outputting the digital signal of the comparator; and
b) at least one second photocell for generating a second analog signal corresponding the received quantity of light.

8. The image sensor as claimed in claim 7, wherein the digital signal is a digital signal having a 1-bit structure.

9. The image sensor as claimed in claim 7, wherein the reference signal is an analog signal of an adjacent photocell of an adjacent pixel.

10. The image sensor as claimed in claim 7, wherein the reference signal is a reference voltage.

11. The image sensor as claimed in claim 7, wherein at least one of the first and second photocells comprises a photo diode and a transistor, the photodiode generating a photocurrent corresponding to the received quantity of light.

12. The image sensor as claimed in claim 7, wherein the comparator is a latch type comparator which outputs a first signal when the analog signal of any one of the first and second photocells is greater than the reference signal and outputs a second signal when the analog signal of any one of the first and second photocells is less than the reference signal.

13. The image sensor as claimed in claim 7, wherein the second photocell is arranged inside each of the plurality of pixels.

14. The image sensor as claimed in claim 7, wherein the second photocell is arranged outside each of the plurality of pixels.

15. An optical pointing system comprising:
a) a plurality of pixels, each having
a photocell for receiving light and generating an analog signal corresponding to a quantity of the received light, and
a comparator for comparing the analog signal of the photocell and a reference signal and generating a digital signal having a value of the compared result;
b) an image processor for calculating a movement value using the digital signals outputted from the plurality of pixels and generating a pixel select signal and a shutter control information signal; and
c) a shutter control circuit for generating a shutter control signal corresponding to the shutter control information signal of the image processor.

16. The optical pointing system as claimed in claim 15, wherein each of the plurality of pixels further comprises a switch for outputting the digital signal of the comparator under the control of the pixel select signal.

17. An optical pointing system comprising:
a) a plurality of pixels, each having
a first photocell for generating a first analog signal corresponding to a received quantity of light, and
a comparator for comparing the first analog signal of the first photocell and a reference signal and generating a digital signal having a value of the compared result;
b) at least one second photocell for generating a second analog signal corresponding the received quantity of light;
c) an image processor for calculating a movement value using the digital signals outputted from the comparators and generating a pixel select signal; and
d) a shutter control circuit for generating a shutter control signal using the second analog signal outputted from the second photocell.

18. The optical pointing system as claimed in claim 17, wherein each of the plurality of pixels further comprises a switch for transmitting the digital signal outputted from the comparator in response to the pixel select signal.

19. The optical pointing system as claimed in claim 18, wherein the second photocell is arranged inside each of the plurality of pixels.
